(19) United States
(12) Patent Application Publication
(10) Pub. No.: US 2019/0264651 A1
(43) Pub. Date: Aug. 29, 2019

(54) SHEAR WEB FOR A WIND TURBINE BLADE

(71) Applicant: Vestas Wind Systems A/S, Aarhus N. (DK)

(72) Inventor: Steve Wardropper, New Milton, Hampshire (GB)

(21) Appl. No.: 16/345,941

(22) PCT Filed: Oct. 30, 2017
(86) PCT No.: PCT/DK2017/050357

§ 371 Date: Apr. 29, 2019

(30) Foreign Application Priority Data
Nov. 1, 2016 (DK) PA 2016 70863

(51) Int. Cl. F03D 1/06; F03D 13/10; B25B 5/14

(52) U.S. Cl. CPC F03D 1/0683; F03D 13/10; F05B 2230/61; F05B 2230/604; F05B 2240/301; B25B 5/14

(57) ABSTRACT

A shear web for a wind turbine, the shear web having a lattice structure comprising: a first longitudinal member defining a mounting flange and a first connection portion; a second longitudinal member defining a mounting flange and a second connection portion; a plurality of first bracing elements connected between the first and second connection portions; and a plurality of second bracing elements connected between the first and second connection portions, the connections between the bracing elements and the longitudinal members defining a plurality of nodes, and wherein at one or more nodes, a connection portion of a longitudinal member is adhesively bonded between a first and a second bracing element.

### TECHNICAL FIELD

The present invention relates to a shear web for a wind turbine blade, and to an assembly tool and associated method for assembling the shear web.

### BACKGROUND

Modern wind turbine blades typically comprise a hollow shell that defines an internal cavity of the blade. One or more reinforcing structures in the form of shear webs may be provided within the internal cavity. The shear webs extend longitudinally along the blade and are bonded between opposed inner surfaces of the blade shell.

The shear webs are typically moulded composite structures, which are formed in a dedicated shear web mould. The moulding process may involve arranging a number of fibre fabric layers and various other constituent materials in the mould to form a ‘layup’. Resin is then admitted into the mould and infuses throughout the layup. The resin is cured by applying heat and pressure to the layup until the resin hardens and the resulting shear web is then removed from the mould.

The moulding process is time-consuming and technically challenging. Additional finishing processes may also be required after moulding, which adds further complexity, time and cost to the manufacturing process. Furthermore, if shear webs of different dimensions are required, then new moulds must be created. The significant cost and lead-time of creating new moulds generally prohibits varying the shear web design, and few manufacturing facilities would have sufficient floor space to accommodate multiple moulds of such large size.

During the moulding process, there is also a requirement to apply heat and pressure to the entire layup to cure the resin. As shear webs for modern utility-scale wind turbine blades are very large components, there is a significant energy cost associated with providing this heat and pressure across the entire structure. The large quantity of resin that is required also means that the material cost for a moulded shear web is relatively high.

EP2679804A1 describes an alternative design of shear web, which has a lattice structure. Such shear webs are advantageously lightweight yet strong, and do not need to be formed in moulds. However, one problem with such shear webs is that they can be relatively complicated to assemble since they are made up from a large number of individual parts, which are typically bolted together. The joints between the bolted parts may also be prone to loosening over time with bending and flexing of the shear web in use. These factors may explain why lattice shear webs have not been seen in large-scale production to date.

Against this background, there is a need for an improved lattice shear web and an associated assembly process that is both reliable and simple.

### SUMMARY OF THE INVENTION

According to a first aspect of the invention, there is provided a shear web for a wind turbine. The shear web has a lattice structure comprising: a first longitudinal member defining a mounting flange and a first connection portion; a second longitudinal member defining a mounting flange and a second connection portion; a plurality of first bracing elements connected between the first and second connection portions; and a plurality of second bracing elements connected between the first and second connection portions. The connections between the bracing elements and the longitudinal members define a plurality of nodes. At one or more of the nodes, a connection portion of a longitudinal member is adhesively bonded between a first and a second bracing element.

Embodiments of the lattice shear web of the invention are advantageously lightweight and strong. Furthermore, the one or more adhesive bonds are advantageously reliable and durable over the lifetime of the shear web. Embodiments of the shear web of the invention are also relatively straightforward and quick to manufacture.

The first longitudinal member may be substantially identical to the second longitudinal member. The first bracing elements may be substantially identical to the second bracing elements. This reduces the number of different parts needed to assemble the shear web.

The longitudinal members and the bracing elements may be pultruded components. This allows the shear web components to be manufactured relatively easily and inexpensively.

At the one or more nodes, the first bracing element may be bonded to a first side of the connection portion; the second bracing element may be bonded to a second side of the connection portion. As such, at the one or more nodes, the connection portion may be located between said first and second bracing elements. This allows a clamping force to be applied to the bracing elements to ensure a strong adhesive bond.

The first and/or second longitudinal members may be substantially T-shaped in cross-section. The upstand of the T-shape may define the connection portion of the longitudinal member. The flange of the T-shape may define a mounting flange of the shear web.

The connection portion of the first and/or second longitudinal members may be provided with a plurality of apertures each located at a respective node. Each end of the first and second bracing elements may be provided with an aperture. At the one or more nodes, an aperture in the longitudinal member may be aligned with apertures in both the first and second bracing elements. This allows the shear web to be assembled accurately and relatively quickly.

The first and second bracing elements may be arranged diagonally relative to the longitudinal members. The bracing elements may be arranged in a truss structure. More specifically, the bracing elements may be arranged in a cross-bracing configuration. This contributes to the strength of the shear web.

According to another aspect of the invention, there is provided a wind turbine blade comprising a shear web as described above.

According to another aspect of the invention, there is provided a kit of parts for assembling together to form a shear web as described above. The kit comprises: a first longitudinal member; a second longitudinal member; and a plurality of bracing elements. The first and second longitudinal members are substantially T-shaped in cross-section.

According to another aspect of the invention, there is provided an assembly tool for assembling a wind turbine blade shear web having a lattice structure. The tool comprises: a first row of support elements mutually spaced apart in a longitudinal direction; and a second row of support elements mutually spaced apart in the longitudinal direction, the second row of support elements being spaced apart from the first row of support elements in a transverse direction. The first row of support elements is arranged to support a first longitudinal member of the lattice shear web. The second row of support elements is arranged to support a second longitudinal member of the lattice shear web. Each support element is further arranged to support one or more bracing elements of the shear web. Each support element comprises a clamping device configured to exert a clamping force between the longitudinal member and the one or more bracing elements when the longitudinal member and the one or more bracing elements are supported by the support element.

Each support element may comprise a location pin arranged to extend through mutually aligned apertures provided in the longitudinal members and bracing elements when supported on the tool. This allows a shear web to be arranged accurately on the assembly tool.

The clamping device may comprise a cylinder, in which case the location pin may be configured to extend and retract relative to the cylinder to effect clamping. A puck or such like may be located on a free end of the location pin to provide a clamping surface. Each support element may include a heating element.

The assembly tool may comprise a plurality of yokes, wherein each yoke extends transversely between a support element in the first row and a support element in the second row. The support elements may be movable in relation to their respective yokes.

The assembly tool may comprise a plurality of legs arranged to support the plurality of yokes above a foundation surface. The foundation surface may be a floor, wall or table. The foundation surface may comprise engagement features that allow the assembly tool to be arranged on the foundation surface according to one or more predefined footprints.

According to another aspect of the invention, there is provided a method of assembling the previously-described shear web using the assembly tool described above. The method comprises the following steps in any suitable order: arranging the plurality of first bracing elements on the assembly tool such that a first end of each first bracing element is supported by a support element in the first row of support elements and a second end of each first bracing element is supported by a support element in the second row of support elements; arranging the first and second longitudinal members on the assembly tool such that the first longitudinal member is supported by each of the support elements in the first row and the second longitudinal member is supported by each of the support elements in the second row; arranging the plurality of second bracing elements on the assembly tool such that a first end of each second bracing element is supported by a support element in the first row of support elements and a second end of each second bracing element is supported by a support element in the second row of support elements; applying adhesive between the longitudinal elements and the bracing elements; and operating the clamping device of each support element to exert a clamping force between the bracing elements and longitudinal members to connect the longitudinal members and bracing elements together.

This aspect of the invention advantageously provides a straightforward and quick manufacturing process for a lattice shear web.

The method may comprise maintaining the clamping force during curing of the adhesive. This ensures that the adhesive is appropriately compressed to provide a strong bond.

The method may comprise applying heat to the adhesive via heating devices integrated with the support elements. This accelerates the curing of the adhesive.

### BRIEF DESCRIPTION OF THE DRAWINGS

In order that the invention may be more readily understood, an embodiment of the invention will now be described by way of non-limiting example with reference to the accompanying figures, in which:

FIG. 1 is a perspective view of a lattice shear web comprising two longitudinal members and a plurality of bracing elements;

Fig. 1a shows an enlarged view of a portion of the lattice shear web;

FIG. 2 is a side view of the lattice shear web;

FIG. 3 is a perspective view of an end portion of a longitudinal member of the lattice shear web shown in isolation;

FIG. 4 is a perspective view of a bracing element of the lattice shear web shown in isolation;

FIG. 4a is a plan view of the bracing element of FIG. 4;

FIG. 5 is a perspective view of a portion of an assembly tool which may be used in the manufacture of the lattice shear web;

FIG. 6 shows a support element of the assembly tool;

FIG. 7 shows a lattice shear web assembled on the assembly tool;

FIGS. 8a to 10c show a series of schematic cross-sectional views of the support element of the assembly tool illustrating steps involved in a method of making a lattice shear web, in which:

FIGS. 8a to 8e illustrate part of the lattice shear web being assembled on the support element;

FIGS. 9a to 9d illustrate a clamping and bonding process between the component parts of the lattice shear web; and

FIGS. 10a to 10c illustrate the lattice shear web being removed from the assembly tool.

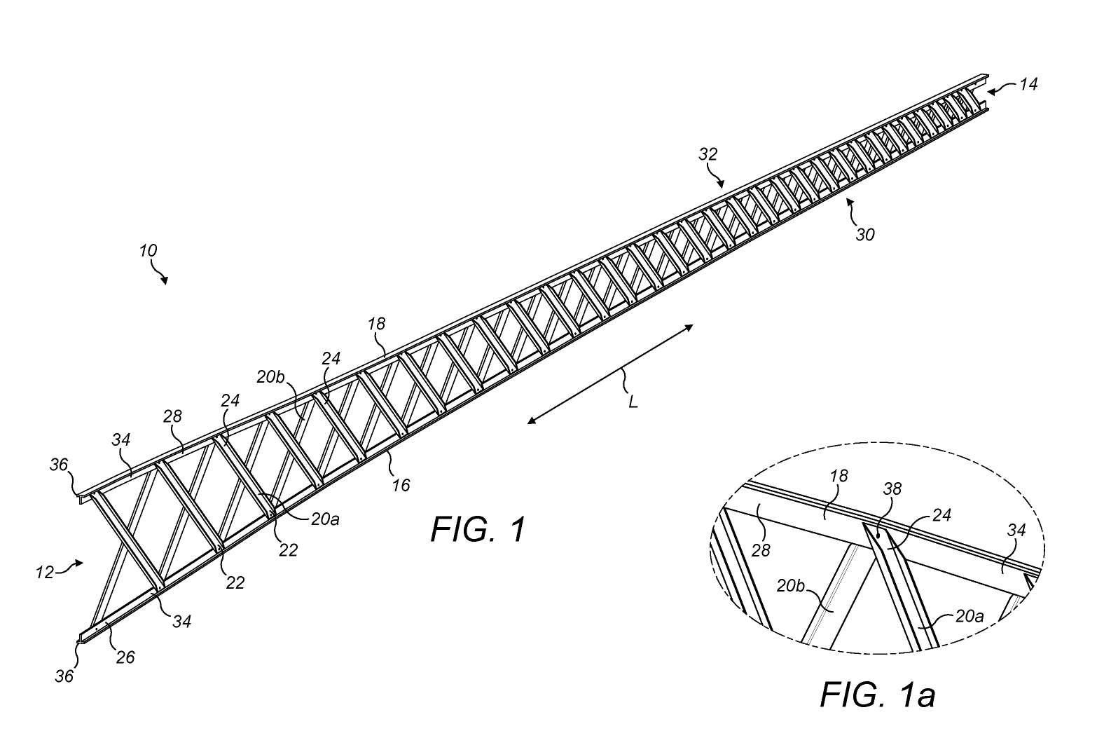

Referring to FIG. 1, a lattice shear web 10 for a wind turbine blade is shown in perspective view. The shear web 10 extends in a longitudinal direction L between a root end 12 and a tip end 14. The shear web 10 has a lattice structure and comprises first and second substantially identical longitudinal members 16, 18 and a plurality of bracing elements, two of which are labelled 20a and 20b in FIG. 1. The bracing elements 20a, 20b are connected between the longitudinal members 16, 18 in a truss structure. When installed in a blade, the longitudinal members 16, 18 of the shear web 10 are bonded to opposed inner surfaces of the blade shell and the bracing elements 20a, 20b bridge the internal cavity of the blade.

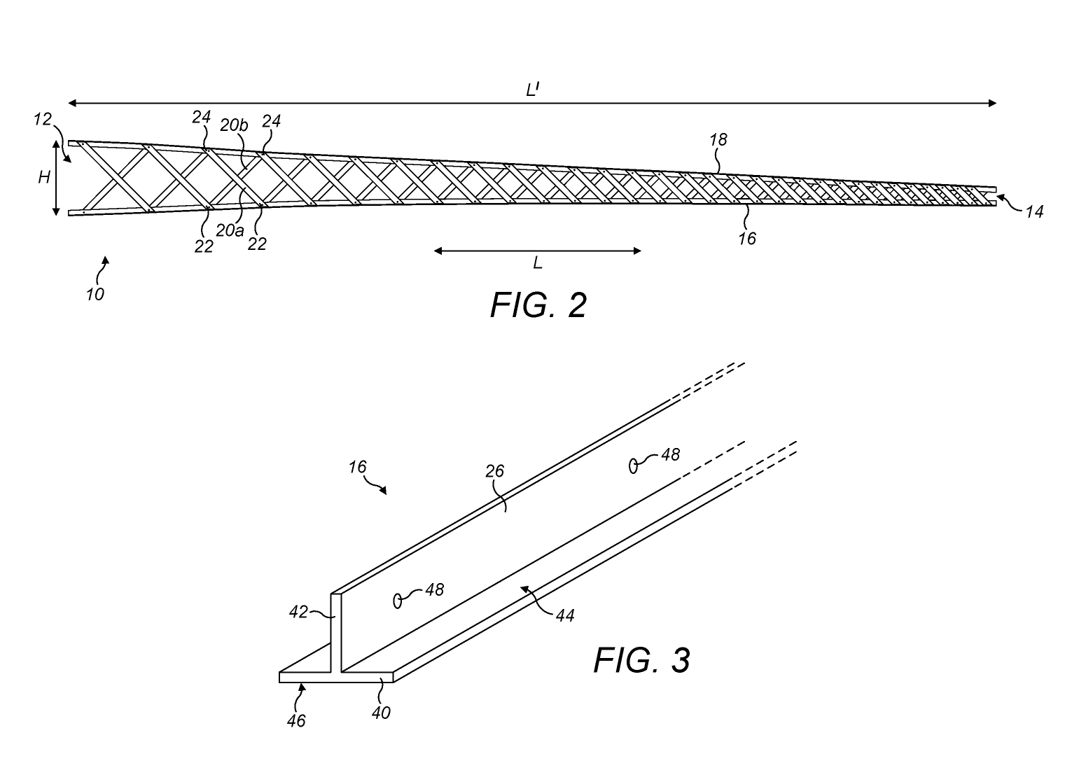

Referring to the side view of FIG. 2, the longitudinal extension of the longitudinal members 16, 18 in the longitudinal direction L defines a length dimension L′ of the lattice shear web 10. A height dimension H of the shear web 10 is defined by the perpendicular spacing between the two longitudinal members 16, 18.

It can be seen in FIG. 2 that the shear web 10 decreases (tapers) in height progressively moving from the root end 12 to the tip end 14 of the shear web 10. The tapering height allows the shear web 10 to be accommodated within a wind turbine blade shell that tapers in height (thickness) moving from root to tip.

A principal plane of the shear web 10 is herein defined as a plane comprising the length and height dimensions L′, H of the shear web 10, i.e. the plane of the page in FIG. 2.

The bracing elements 20a, 20b of the shear web 10 extend between the longitudinal members 16, 18 in the principal plane of the shear web 10. In this example, the bracing elements 20a, 20b are arranged in a cross-bracing configuration. The bracing elements 20a, 20b are each arranged diagonally within the principal plane of the shear web 10. That is to say, the bracing elements 20a, 20b are arranged such that first and second ends 22, 24 of each bracing element 20a, 20b are spaced apart from one another in the longitudinal direction. In this example, the bracing elements 20a, 20b are arranged at approximately 45 degrees relative to longitudinal members 16, 18.

Each bracing element 20a, 20b is connected at its first end 22 to the first longitudinal member 16 and connected at its second end 24 to the second longitudinal member 18. The shear web 10 comprises two sets of bracing elements: a first set comprising a plurality of first bracing elements 20a and a second set comprising a plurality of second bracing elements 20b. Each first bracing element 20a is arranged diagonally substantially in the principal plane of the shear web 10 such that its first end 22 is closer to the tip end 14 of the shear web 10 than its second end 24 is. Conversely, each second bracing element 20b is arranged diagonally substantially in the principal plane of the shear web 10 such that its first end 22 is closer to the root end 12 of the shear web 10 than its second end 24 is. The first and second bracing elements 20a, 20b are therefore arranged in contrary diagonal directions. Pairs of first and second bracing elements 20a, 20b cross over as they extend between the longitudinal members 16, 18, forming X shapes in this example.

Referring again to FIG. 1 and also to the detail view in FIG. 1 a, the first and second longitudinal members 16, 18 each comprise a connection portion 26, 28 to which the bracing elements 20a, 20b are connected. In particular, the first longitudinal member 16 comprises a first connection portion 26 and the second longitudinal member 18 comprises a second connection portion 28. The first end 22 of each bracing element 20a, 20b is connected to the first connection portion 26 and the second end 24 of each bracing element 20a, 20b is connected to the second connection portion 28.

In this example, the first bracing elements 20a are disposed on a first side 30 of the shear web 10, and the second bracing elements 20b are disposed on a second side 32 of the shear web 10, opposite the first side 30. The first and second sides 30, 32 of the shear web 10 may be defined by opposed first and second sides 34, 36 of the connection portions 26, 28. In this example, the first and second ends 22, 24 of the first bracing elements 20a are connected respectively to a first side 34 of the first connection portion 26 and to a first side 34 of the second connection portion 28. In contrast, the first and second ends 22, 24 of the second bracing elements 20b are connected respectively to a second side 36 of the first connection portion 26 and to a second side 36 of the second connection portion 28.

The connections between the longitudinal members 16, 18 and the bracing elements 20a, 20b define a plurality of nodes 38 of the lattice shear web 10. A node position 38 can be seen in the enlarged view of FIG. 1 a. At this node position 38, a first bracing element 20a and a second bracing element 20b are connected to the second connection portion 28. Specifically, a second end 24 of the first bracing element 20a is connected to the first side 34 of the second connection portion 28, whilst a second end 24 of a second bracing element 20b is connected to the second side 36 of the second connection portion 28. Accordingly, the connection portion 28 is located between the first and second bracing elements 20a, 20b. More specifically, the second connection portion 28 is sandwiched between the respective second ends 24 of the first and second bracing elements 20a, 20b.

As discussed in more detail later, the first and second bracing elements 20a, 20b are bonded to the connection portions 26, 28 at the nodes. For each node, with the exception of the nodes at the extreme ends 12, 14 of the shear web 10, the connection portions 26, 28 of the longitudinal members 16, 18 are bonded between a first and second bracing element 20a, 20b.

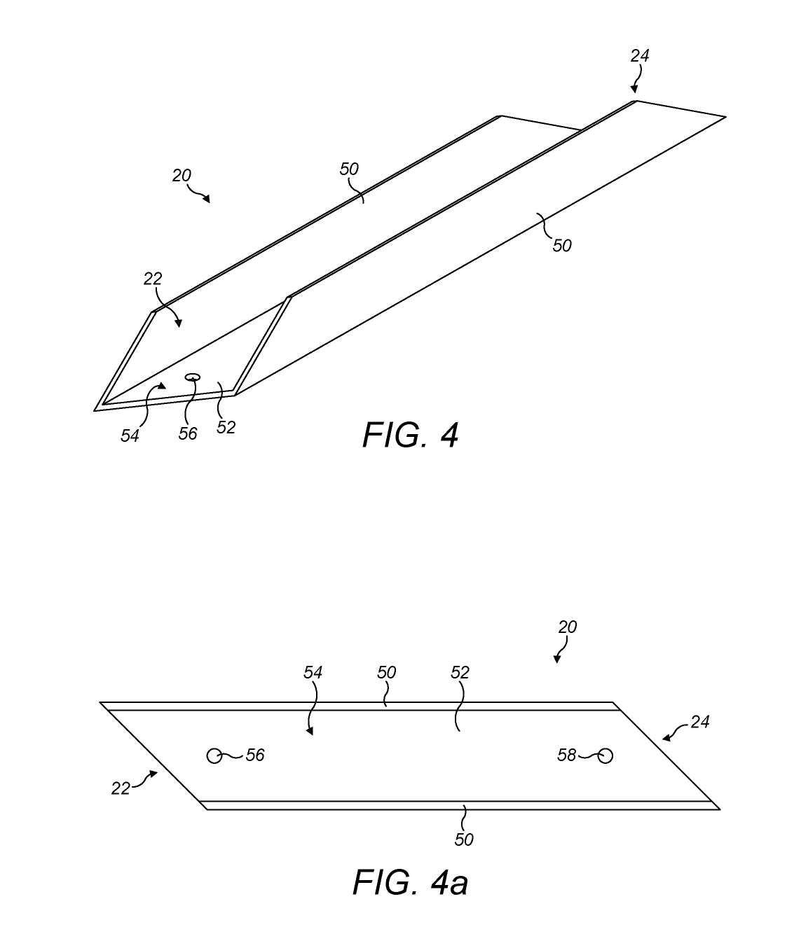

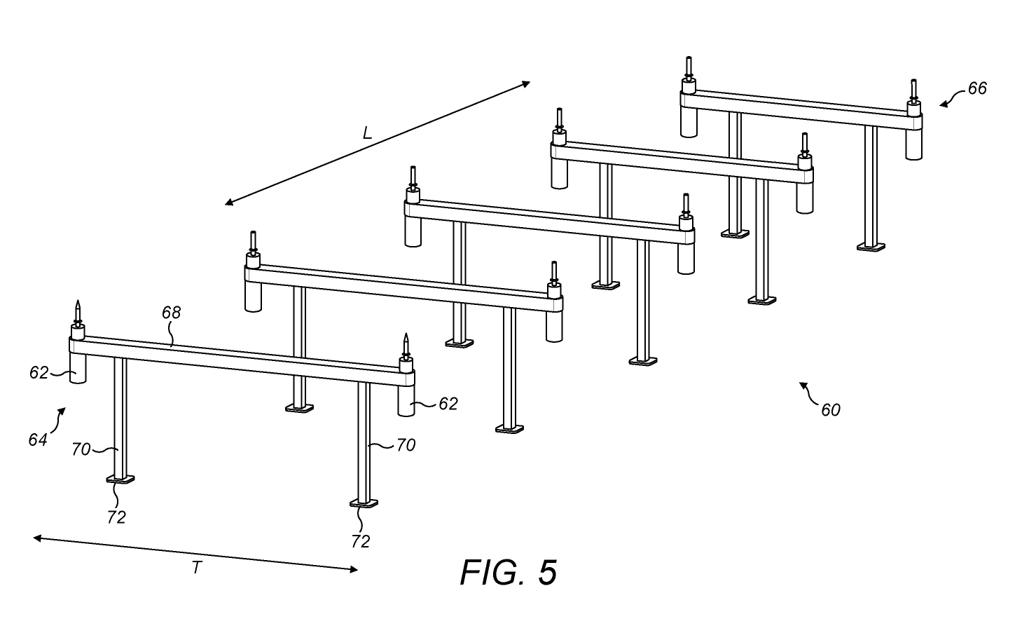

The components of the shear web 10 will now be described in more detail with reference to FIGS. 3, 4 and 4a.

FIG. 3 shows a portion of a longitudinal member 16 in perspective view. In this embodiment, the first and second longitudinal members 16, 18 are substantially identical components. The longitudinal member 16 has a substantially T-shaped cross-section comprising a mounting flange 40 and an upstand 42. The upstand 42 projects from an inner surface 44 of the flange 40. The upstand 42 defines the connection portion 26 of the longitudinal member 16. An outer surface 46 of the flange 40 defines a bonding surface of the longitudinal member 16 which may be bonded to the inner surface of a blade shell when the lattice shear web 10 is installed in a wind turbine blade. The longitudinal member 16 in this example is of substantially constant cross section along its length.

As shown in FIG. 3, a plurality of apertures 48 are provided in the connection portion 26 of the longitudinal member 16. In this example each aperture 48 is in the form of a circular hole. The apertures 48 are mutually spaced along the length of the longitudinal member 16. In this example the apertures 48 are evenly spaced at regular intervals along the length of the shear web 10. Each aperture 48 is provided at a node position 38. As will be described in more detail later, the apertures 48 are utilised during assembly of the lattice shear web 10 to locate the component parts of the shear web 10 accurately at the node positions 38.

Referring now to FIGS. 4 and 4a, a bracing element 20 is shown in perspective and plan views respectively. As shown in FIG. 4a, the bracing element 20 in this example is in the form of a ‘U-channel’ or ‘U-beam’, and is an elongate structure having a substantially U-shaped cross-section, which is defined by a pair of legs or side-walls 50 extending from a flat base or intermediate portion 52. The intermediate portion 52 comprises inner and outer surfaces, of which only the inner surface 54 is visible in FIGS. 4a and 4b.

The bracing element 20 is of substantially constant cross-section along its length. As shown in the plan view of FIG. 4b, the first and second ends 22, 24 of the intermediate portion 52 are angled such that intermediate portion 52 is shaped as a parallelogram in plan view. The side walls 50 extend perpendicularly from the intermediate portion 52. In this example, the side walls 50 are tapered at each end 22, 24 of the bracing element 20.

The first and second ends 22, 24 of the bracing element 20 each comprise a respective aperture 56, 58, which in this example is in the form of a circular hole. Specifically, a first aperture 56 is provided in the intermediate portion 52 at the first end 22 of the bracing element 20 and a second aperture 58 is provided in the intermediate portion 52 at the second end 24 of the bracing element 20. As will be described in more detail later, the apertures 56, 58 are utilised during assembly of the lattice shear web 10 to locate the component parts of the shear web 10 accurately at the node positions 38.

In this example, each of the bracing elements 20a, 20b of the lattice shear web 10 has the same general structure. The description above therefore applies to each bracing element 20a, 20b. However, it should be noted the lattice shear web 10 may comprise bracing elements 20a, 20b of different lengths to accommodate the varying or tapering height of the shear web 10, for example as shown in FIGS. 1 and 2.

Preferably, the longitudinal members 16, 18 and the bracing elements 20a, 20b may be formed from the same or similar materials and using the same or similar manufacturing techniques. The longitudinal members 16, 18 and/or the bracing elements 20a, 20b are preferably composite components, which are preferably formed from glass-fibre reinforced plastic (GFRP), but may alternatively or additionally include other reinforcing fibres, for example carbon fibres. Preferably the longitudinal members 16, 18 and/or the bracing elements 20a, 20b are pultruded components formed by pultrusion. To form the longitudinal members 16, 18, a pultrusion die having a T-shaped cross-section may be used, whilst to form the bracing elements 20a, 20b a pultrusion die having a U-shaped cross-section may be used.

The bracing elements 20a, 20b and longitudinal members 16, 18 may be cut to the required length as they emerge from the pultrusion die and optionally packed into kits ready for assembling into a lattice shear web 10. As all the bracing elements 20a, 20b may have the same cross-section, irrespective of their length, the process of manufacturing the component parts 16, 18, 20a, 20b of the shear web 10 is relatively straightforward. The apertures 48, 56, 58 in the various components 16, 18, 20a, 20b may be created inline with the pultrusion process or afterwards, for example by drilling or punching holes.

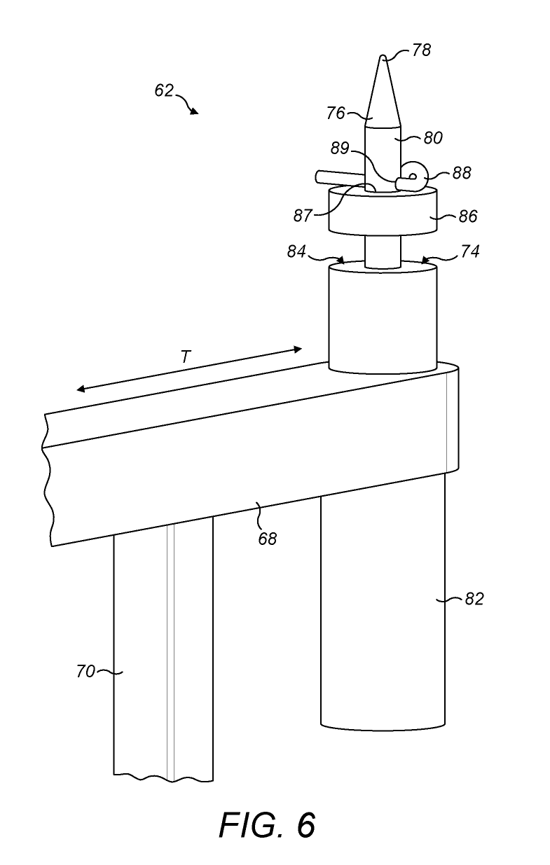

A process for manufacturing a shear web 10 in accordance with an example of the present invention will now be described with reference to FIGS. 5 to 10.

FIG. 5 shows a portion of an assembly tool 60 that may be used in the assembly of the lattice shear web 10 from its component parts 16, 18, 20a, 20b. The assembly tool 60 is in the form of a jig and includes an array of support elements 62, two of which are labelled in FIG. 5. In particular, the array comprises two longitudinally extending rows 64, 66 of support elements 62. Each row 64, 66 comprises a plurality of support elements 62 mutually spaced apart in the longitudinal direction L. The first and second rows 64, 66 are spaced apart from each other in a transverse direction T. In this example, the array of support elements 62 comprises a plurality of mutually opposed pairs of support elements 62, each pair comprising a support element 62 in the first row 64 and a corresponding support element 62 in the second row 66. Each pair of support elements 62 is spaced apart from an adjacent pair in a longitudinal direction L. As will be explained in more detail, each support element 62 corresponds to a node position 38 of the shear web 10.

The support elements 62 may be mounted on a frame structure. In this example, the frame structure comprises a plurality of yokes 68. Each yoke 68 extends in a transverse direction T between a mutually opposed pair of support elements 62. The corresponding support elements 62 are thus provided at either end of the yoke 68. Each yoke 68 is supported by a pair of substantially parallel legs 70 that may be secured to a suitable foundation surface such as a floor, table or wall. In this example, the legs 70 are provided with feet 72 that may be secured to the foundation surface.

The foundation surface may comprise engagement features that allow the assembly tool 60 to be arranged on the foundation surface according to one or more predefined footprints. The foundation surface may comprise a plurality of mounting points for the legs 70. The mounting points may comprise one or more threaded bores for receiving bolts (not shown) that extend through the feet 72 at the ends of the legs 70, although other means for securing the legs 70 to the foundation surface may be envisaged by the skilled person. If the foundation surface accommodates more than one predefined footprint then the assembly tool 60 can be arranged in more than one configuration (re-configured) to allow shear webs of varying designs to be assembled using the assembly tool 60.

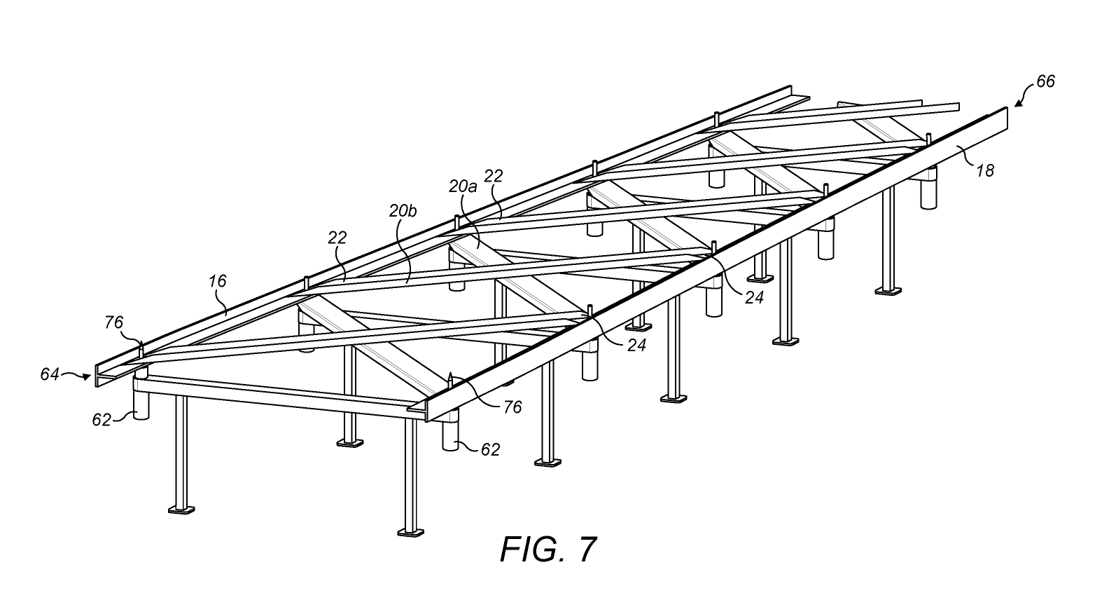

The support elements 62 will now be described in more detail with reference to FIG. 6 which shows an enlarged view of a support element 62 of the assembly tool 60. Each support element 62 is substantially identical in this example.

As shown in FIG. 6, the support element 62 comprises a support surface 74 and a location pin 76. The location pin 76 projects substantially perpendicularly from the support surface 74. In the orientation of the support element 62 shown in FIG. 6, the location pin 76 projects upwardly from the support surface 74. The location pin 76 in this example has a tapered or chamfered end 78. As will be described in more detail later, the location pin 76 passes through the holes 48, 56, 58 provided in the respective component parts 16, 18, 20a, 20b when the parts 16, 18, 20a, 20b are arranged on the assembly tool 60. The chamfered end 78 facilitates insertion of the pin 76 through the respective holes 48, 56, 58.

The support element 62 in this example includes a piston 80 and cylinder 82 arrangement. An end surface 84 of the cylinder 82 defines the support surface 74. The location pin 76 is in the form of a piston rod 80 that extends and retracts relative to the cylinder 82. The piston 80 and cylinder 82 may be pneumatic or hydraulic. In other embodiments, a hand crank or electric motor may be used to extend or retract the location pin 76.

The support element 62 also comprises a puck 86. The puck 86 includes a through-bore 87 that allows the puck 86 to be inserted onto or removed from the location pin 76. The puck 86 is retained on the location pin 76 by a retaining pin 88, which is inserted through a hole 89 provided in the location pin 76. As will be described in more detail later, the piston 80, cylinder 82 and puck 86 arrangement together form a clamping device configured to exert a clamping force on the shear web components 16, 18, 20a, 20b when they are assembled on the assembly tool 60.

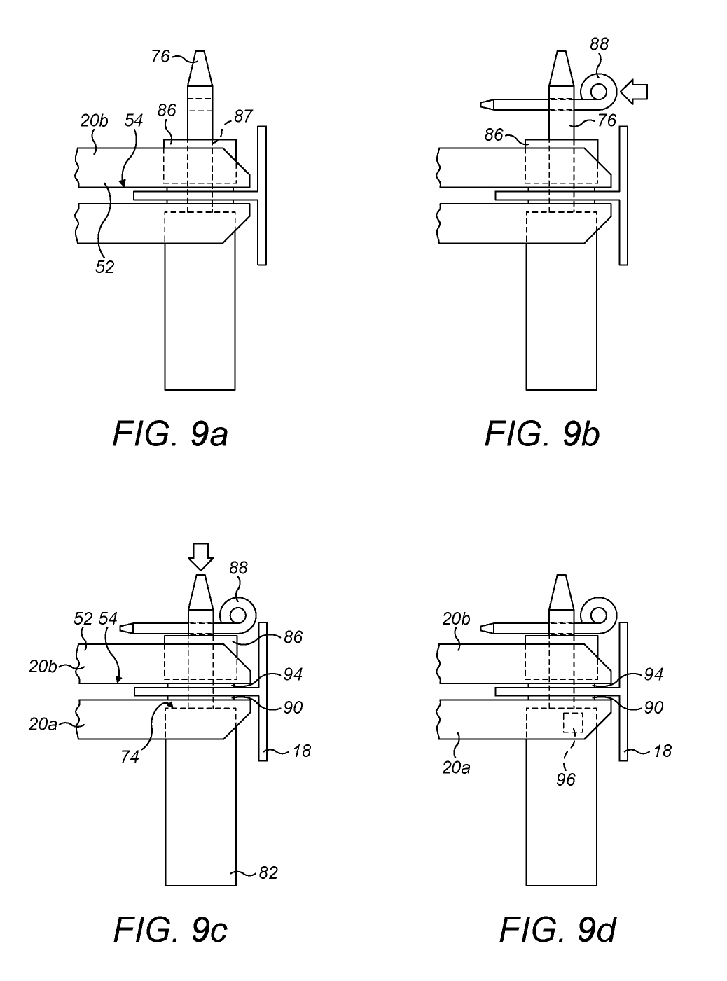

The support element 62 also preferably comprises a heating element (not shown). In this example, the heating element is integrated with the cylinder (as shown schematically in FIG. 9d). The heating element may be integrated with the puck 86 and/or with the cylinder 82 and/or with the location pin 76, or it may be a separate device. The heating element is configured to apply heat to the shear web components 16, 18, 20a, 20b when they are arranged on the assembly tool 60.

In some examples, the support element 62 may be movable with respect to the frame of the assembly tool. For example, the support element 62 may be movable in a transverse direction T (see FIG. 5) along a portion of the length of the yoke 68. This allows the assembly tool 60 to be adjusted to allow shear webs of different heights to be assembled on the assembly tool 60.

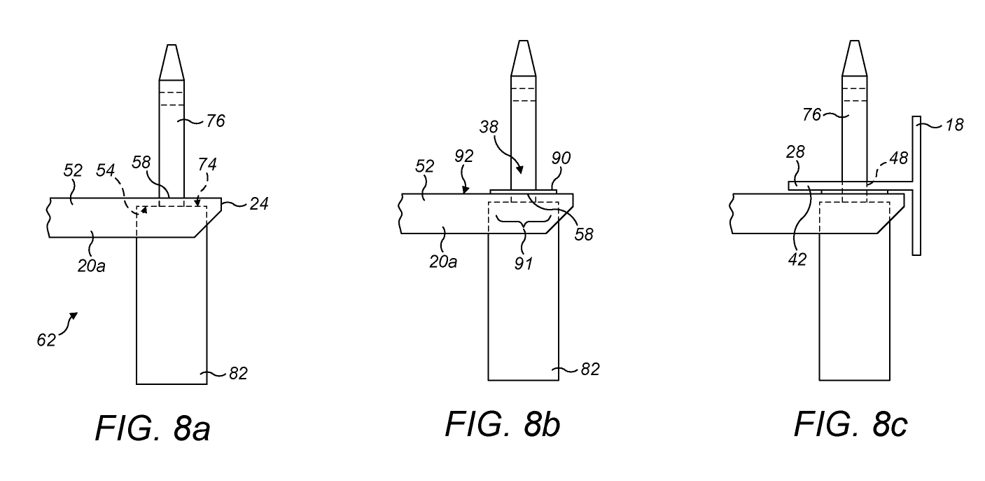

A method of making a lattice shear web 10 will now be described with reference to FIGS. 7 to 10.

FIG. 7 shows a portion of the assembly tool 60 with the shear web components 16, 18, 20a, 20b arranged on the location pins 76. As will be discussed in more detail later, the process of assembling the shear web 10 initially involves arranging the first bracing elements 20a on the support elements 62 of the assembly tool 60. The first bracing elements 20a are arranged diagonally, such that each element 20a is supported by a pair of longitudinally spaced support elements 62: one in the first row 64 and one in the second row 66. Next, the two longitudinal members 16, 18 are arranged on the support elements 62. The first and second longitudinal members 16, 18 are supported by the first and second rows 64, 66 of support elements respectively. Thereafter, the second bracing elements 20b are arranged on the support elements 62, with each second bracing element 20b being arranged diagonally in an opposite direction to the first bracing elements 20a.

The shear web components 16, 18, 20a, 20b are arranged on the assembly tool 60 such that the location pins 76 of the support elements 62 extend through the mutually-aligned holes 48, 56, 58 defined in the connection portions 26, 28 of the longitudinal members 16, 18 and at the ends 22, 24 of the bracing elements 20a, 20b. Thus, each location pin 76 corresponds to a node position 38 of the shear web 10. The location pins 76 and holes 48, 56, 58 conveniently allow the shear web components 16, 18, 20a, 20b to be arranged quickly, simply and accurately on the assembly tool 60.

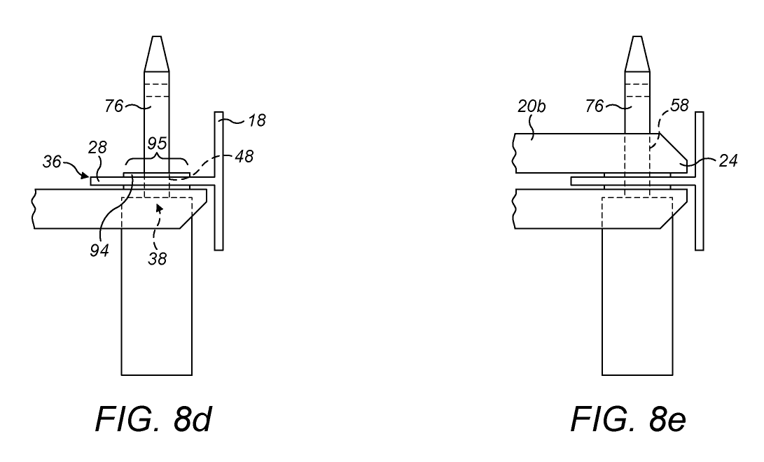

The shear web assembly process using the assembly tool 60 will now be discussed in more detail with reference to FIGS. 8a to 10c, which schematically show the component parts of the shear web 10 being assembled at one of the support elements 62 of the assembly tool.

Referring to FIG. 8a, the support element 62 is initially arranged with its puck 86 removed and with its location pin 76 extending fully from the cylinder 82. A first bracing element 20a is then arranged on the assembly tool 60. The first bracing element 20a is arranged such that the location pin 76 extends through the hole 58 in one end 24 of the bracing element 20a. The inner surface 54 of the intermediate portion 52 of the first bracing element 20a lies against the support surface 74 of the cylinder 82. The other end (not shown) of the first bracing element 20a is similarly supported on another support element 62 in the adjacent row 64 of support elements 62 (see for example FIG. 7).

Referring to FIG. 8b, a layer of adhesive 90 is then applied to the outer surface 92 of the intermediate portion 52 of the first bracing element 20a at the node position 38. In this example, the adhesive 90 is applied to a region 91 surrounding the hole 58 through which the location pin 76 extends.

Referring to FIG. 8c, a longitudinal member 18 is then arranged on the assembly tool 60. The longitudinal member 18 is arranged such that the location pin 76 extends through one of the holes 48 provided in the connection portion 28 of the longitudinal member 18, i.e. in the upstand 42 of the T in this embodiment. The longitudinal member 18 is similarly supported by each of the other support elements (not shown) in the same row (see for example FIG. 7).

Referring to FIG. 8d, a layer of adhesive 94 is then applied to the second surface 36 of the connection portion 28 of the longitudinal member 18 at the node position 38. The adhesive 94 is applied to a region 95 surrounding the hole 48 through which the location pin 76 extends.

Referring to FIG. 8e, a second bracing element 20b is then arranged on the assembly tool 60. The second bracing element 20b is arranged such that the location pin 76 extends through the hole 58 in one end 24 of the bracing element 20b. The other end (not shown) of the second bracing element 20b is similarly supported on another support element 62 in the adjacent row 64 of support elements 62 (see for example FIG. 7).

Once the lattice shear web components 16, 18, 20a, 20b have been assembled on the assembly tool 60, the layup is subjected to a clamping and curing process to integrate the various components 16, 18, 20a, 20b together, as illustrated by FIGS. 9a to 9d.

Referring to FIG. 9a, the puck 86 is inserted on the location pin 76 such that the location pin 76 extends through the hole 87 in the centre of the puck 86. The puck 86 initially sits against the inner surface 54 of the intermediate portion 52 of the second bracing element 20b.

Referring to FIG. 9b, the retaining pin 88 is then inserted through the location pin 76 to retain the puck 86 on the location pin 76.

Referring to FIG. 9c, with the puck 86 and retaining pin 88 in place, the location pin 76 is then retracted relative to the cylinder 82. Retraction of the location pin 76 causes the retaining pin 88 to bear against the puck 86, and the puck 86 in turn bears against the inner surface 54 of the intermediate portion 52 of the second bracing element 20b. Accordingly, a clamping force is applied to the assembled components 20a, 18, 20b of the shear web 10 between the support surface 74 of the cylinder 82 and the puck 86. The clamping force serves to compress the adhesive 90, 94 applied between the respective components 20a, 18, 20b.

Referring to FIG. 9d, with the clamping force maintained, the heating element 96 is optionally activated in order to apply heat to the shear web components 20a, 18, 20b to accelerate curing of the adhesive 90, 94. Under the pressure provided by the clamping device and the heat provided by the heating element 96, the adhesive 90, 94 is cured. This securely joins the components 20a, 18, 20b of the shear web 10 together.

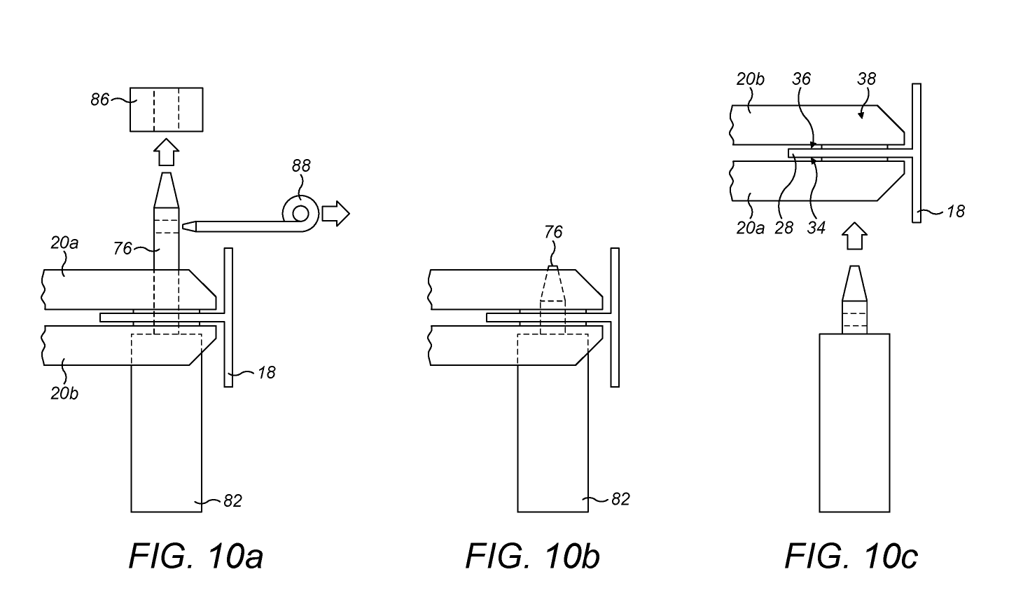

After the adhesive 90, 94 has cured, the lattice shear web 10 is removed from the assembly tool 60, as illustrated by FIGS. 10a to 10c.

Referring to FIG. 10a, the location pin 76 is extended from the piston cylinder 82 to relieve the clamping force on the shear web components 20a, 18, 20b. The retaining pin 88 and puck 86 are then removed from the location pin 76.

Referring to FIG. 10b, the location pin 76 is then retracted again within the piston cylinder 82.

Then, as shown in FIG. 10c, the lattice shear web 10 is removed from the assembly tool 60. At a plurality of nodes 38 of the completed shear web 10, the connection portion 28 of a longitudinal member 18 is bonded between first and second bracing elements 20a, 20b. A first bracing element 20a is bonded to a first side 34 of the connection portion 26, 28, and a second bracing element 20b is bonded to a second side 36 of the connection portion 28.

Variants of the support elements 62 are envisaged with longer location pins 76 allowing multiple shear webs 10 to be assembled simultaneously, one on top of another, on the same assembly jig 60.

It should be appreciated that although the description above refers to a single support element 62, the description is equally relevant to the other support elements 62 of the assembly tool 60. The processes described above may be carried out simultaneously or sequentially at each support element 62 as appropriate.

The lattice shear web 10 described above may advantageously be made from entirely pultruded components. Accordingly, the process of making the component parts 16, 18, 20a, 20b of the shear web is relatively straightforward and quick. The frequency, section, modulus, length etc. of the pultrusions can be altered easily by a straightforward adjustment of the pultrusion die, materials or pultrusion process to suit loads or to vary the dimensions of the shear web 10. The components 16, 18, 20a, 20b may be delivered as a kit of parts and assembled in the assembly jig 60 on site.

The joints between pultrusions are adhesive bonds, which are advantageously strong and durable over the lifetime of the shear web 10 and do not suffer from the problems of bolted joints. The process of manufacturing the shear web 10 is conveniently completely mouldless. The process advantageously allows discrete localised heating of the bond areas. The bond areas of the shear web 10 constitute a relatively small aggregate area of the shear web 10, and therefore there is a significant reduction in the heating requirements for curing in comparison to a moulded shear web where heating is required across the entire shear web.

The assembly jig 60 of the present invention enables the shear web 10 to be assembled from its component parts 16, 18, 20a, 20b rapidly. The process of making the shear web 10 using the jig 60 is considerably faster than the moulding process used to fabricate traditional shear webs. The assembly jig 60 may be reconfigured easily if the dimensions of the shear web 10 need to be varied. The assembly jig 60 can be arranged vertically or horizontally and packed away when not in use to free up floor space in the factory.

Many modifications may be made to the above examples without departing from the scope of the present invention as defined in the accompanying claims. For example, the number, design, position or orientation of the bracing elements 20a, 20b could be adjusted in dependence on the anticipated loads to be experienced by the shear web 10.

1. A shear web for a wind turbine, the shear web having a lattice structure comprising:
a first longitudinal member defining a mounting flange and a first connection portion;
a second longitudinal member defining a mounting flange and a second connection portion;
a plurality of first bracing elements connected between the first and second connection portions; and
a plurality of second bracing elements connected between the first and second connection portions,
the connections between the bracing elements and the longitudinal members defining a plurality of nodes, and
wherein at one or more nodes, a connection portion of a longitudinal member is adhesively bonded between a first and a second bracing element.

2. The shear web of claim 1, wherein at the one or more nodes, the first bracing element is bonded to a first side of the connection portion and the second bracing element is bonded to a second side of the connection portion.

3. The shear web of claim 1, wherein the longitudinal members and the bracing elements are pultruded components.

4. The shear web of claim 1, wherein the first and/or second longitudinal members are substantially T-shaped in cross-section.

5. The shear web of claim 1, wherein the connection portion of the first and/or second longitudinal members is provided with a plurality of apertures each located at a respective node and each end of the first and second bracing elements is provided with an aperture, and wherein at the one or more nodes, an aperture in the longitudinal member is aligned with apertures in both the first and second bracing elements.

6. The shear web of claim 1, wherein the first and second bracing elements are arranged diagonally relative to the longitudinal members.

7. A wind turbine blade comprising a shear web as defined in claim 1.

8. A kit of parts for assembling together to form the shear web of claim 1, wherein the kit comprises:
a first longitudinal member;
a second longitudinal member; and
a plurality of bracing elements,
wherein the first and second longitudinal members are substantially T-shaped in cross-section.

9. An assembly tool for assembling a wind turbine blade shear web having a lattice structure, the tool comprising:
a first row of support elements mutually spaced apart in a longitudinal direction;
a second row of support elements mutually spaced apart in the longitudinal direction, the second row of support elements being spaced apart from the first row of support elements in a transverse direction;
the first row of support elements being arranged to support a first longitudinal member of the lattice shear web; and
the second row of support elements being arranged to support a second longitudinal member of the lattice shear web;
wherein each support element is further arranged to support one or more bracing elements of the shear web, and
wherein each support element comprises a clamping device configured to exert a clamping force between the longitudinal member and the one or more bracing elements when the longitudinal member and the one or more bracing elements are supported by the support element.

10. The assembly tool of claim 9, wherein each support element comprises a location pin arranged to extend through mutually aligned apertures provided in the longitudinal members and bracing elements when supported on the tool.

11. The assembly tool of claim 9, wherein the clamping device further comprises a cylinder and the location pin is configured to extend and retract relative to the cylinder to effect clamping.

12. The assembly tool of claim 9, wherein each support element includes a heating element.

13. The assembly tool of claim 9, wherein the assembly tool further comprises a plurality of yokes, wherein each yoke extends transversely between a support element in the first row and a support element in the second row.

14. The assembly tool of claim 13, further comprising a plurality of legs arranged to support the plurality of yokes above a foundation surface such as a floor, wall or table.

15. A method of assembling the shear web of claim 1 using the assembly tool of claim 9, the method comprising the following steps in any suitable order:
arranging the plurality of first bracing elements on the assembly tool such that a first end of each first bracing element is supported by a support element in the first row of support elements and a second end of each first bracing element is supported by a support element in the second row of support elements;
arranging the first and second longitudinal members on the assembly tool such that the first longitudinal member is supported by each of the support elements in the first row and the second longitudinal member is supported by each of the support elements in the second row;
arranging the plurality of second bracing elements on the assembly tool such that a first end of each second bracing element is supported by a support element in the first row of support elements and a second end of each second bracing element is supported by a support element in the second row of support elements;
applying adhesive between the longitudinal elements and the bracing elements; and
operating the clamping device of each support element to exert a clamping force between the bracing elements and longitudinal members to connect the longitudinal members and bracing elements together.

16. The method of claim 15, comprising maintaining the clamping force during curing of the adhesive.

17. The method of claim 15, comprising applying heat to the adhesive via heating devices integrated with the support elements.
